(19) United States
(12) Patent Application Publication
(10) Pub. No.: US 2013/0268527 A1
(43) Pub. Date: Oct. 10, 2013

(54) PROCESSING ACQUISITION DATA INTO DELIVERABLE FORMAT

(71) Applicant: William T. Block, Friendswood, TX (US)

(72) Inventor: William T. Block, Friendswood, TX (US)

(73) Assignee: BAKER HUGHES INCORPORATED, Houston, TX (US)

(21) Appl. No.: 13/443,092

(22) Filed: Apr. 10, 2012

(51) Int. Cl. G06F 17/30

(52) U.S. Cl. CPC G06F 17/30286
USPC 707/736

(57) ABSTRACT

A method of processing data includes: receiving by an application acquisition data from at least one data acquisition source, the acquisition data having a first data format, the first data format including the acquisition data and business data related to the first data format; instructing a software component to access the acquisition data; and processing the acquisition data by the software component, wherein processing includes separating the acquisition data from the business data and making the acquisition data available to one or more other components via a common interface that can be implemented by the software component and the other components.

### BACKGROUND

Hydrocarbon exploration and production requires substantial generation of data in measuring or monitoring aspects of downhole operations and evaluating downhole and formation conditions. Various types of measurements, such as resistivity and gamma ray measurements for evaluating properties of a formation, force measurements for monitoring and evaluating drilling and other operations, and environmental measurements such as temperature, pressure and fluid properties, are generated and need to be delivered to users.

Well log data is commonly exchanged between companies using industry standard file formats. The two most common file formats which are used to exchange well log data are Digital Log Interchange Standard (DLIS) (Petrotechnical Open Software Corporation, 1991) and Log ASCII Standard (LAS) (Canadian Well Logging Society, 1992). This well log data is typically processed internally within a company via various internal file formats. Supporting numerous file formats presents a challenge to users that need to read and write well log data. Methodologies for storing well log data typically requires multiple applications needed to create, read, write, and convert the various file formats received from well log data generators.

### SUMMARY

A method of processing data includes: receiving by an application acquisition data from at least one data acquisition source, the acquisition data having a first data format, the first data format including the acquisition data and business data related to the first data format; instructing a software component to access the acquisition data; and processing the acquisition data by the software component, wherein processing includes separating the acquisition data from the business data and making the acquisition data available to one or more other components via a common interface that can be implemented by the software component and the other components.

A system for processing data includes: a processor including an application configured to receive acquisition data from at least one data acquisition source, the acquisition data having a first data format, the first data format including the acquisition data and business data related to the first data format; and at least one software component configured to access and process the acquisition data, wherein processing includes separating the acquisition data from the business data and making the acquisition data available to one or more other components via a common interface that can be implemented by the software component and the other components.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a system including a drill string and a formation logging tool;

FIG. 2 illustrates an exemplary acquisition data processing and/or delivery system;

FIG. 3 is a flow diagram illustrating an exemplary method of processing and converting acquisition data;

FIG. 4 illustrates an exemplary virtual data model;

FIG. 5 illustrates a user interface window showing exemplary primary and secondary stores;

FIG. 6 illustrates a user interface window showing an exemplary secondary store;

FIG. 7 is a flow diagram illustrating an exemplary method of processing acquisition data by a data adapter;

FIG. 8 is a flow diagram illustrating an exemplary method of processing acquisition data by a data adapter;

FIG. 9 illustrates a user interface window showing exemplary curve groups;

FIG. 10 illustrates an exemplary knowledge base data collection;

FIG. 11 illustrates an exemplary data collection for use with an acquisition data project;

FIG. 12 is a block diagram illustrating an exemplary use of the data collections of FIGS. 10 and 11;

FIG. 13 illustrates a user interface for exemplary tables for a collection of survey data; and

FIG. 14 illustrates exemplary linked tables.

### DETAILED DESCRIPTION

Disclosed are methods and apparatuses for processing data, such as field data generated from downhole drilling, exploration, evaluation and production operations. The method includes providing an application programming interface (API) implemented by components such as data adapters that are configured to expose properties and methods and hide the details of the underlying data format. A data adapter is provided for each data format that is configured to run only when a specific data format is in use. A respective data adapter extracts the deliverable or acquisition data from an acquisition data source and may store the acquisition data in a format (e.g., as streams). The data adapter is responsible for processing and delivering the acquisition data to a user without requiring the application program to know anything about the specific file format being used. Each data adapter or other component implements a virtual data model (VDM) that provides instructions for communicating between each component and provides a virtual organization of the acquisition data. For example, the VDM associates acquisition data items (e.g., curves, tables) with various elements or objects and organizes the elements or objects such that components can access and view the data according to a common structure. If the acquisition data is to be delivered in a requested format, a respective data adapter reads the data using the VDM and converts the acquisition data into the delivered format.

The data adapters are responsible for creating an abstract interface that makes no assumption about the data format or its limitations. Applications written to this interface can work equally well with any acquisition data file formats or acquisition databases. Virtualization of such data allows for easily and efficiently delivering data having different formats (e.g., file formats and database formats) and containing different types of information in a generic format that is readily accessible to a user without extensive modification or code changes.

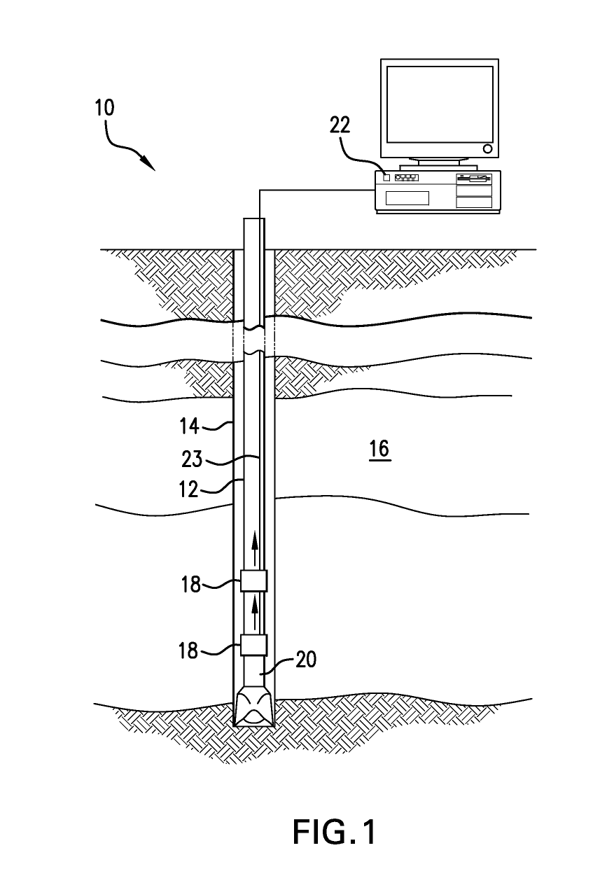

FIG. 1 illustrates an exemplary embodiment of a downhole drilling, exploration, evaluation and/or measurement system 10. The system 10 includes a borehole string 12 disposed in a borehole 14 penetrating an earth formation 16. At least one logging instrument 18 is disposed with the string 12, such as within a string segment or collar, or with a drilling assembly 20. The logging instrument 18 is configured to measure various parameters of the formation, borehole and/or string. Exemplary measurements include pressure, temperature, vibration, resistivity, nuclear magnetic resonance, gamma radiation and acoustic. Measurement data (also referred to as acquisition data) may be transmitted to a data acquisition unit 22 via, for example, a communications cable 23. The data acquisition unit 22 may be, for example, a surface processing unit or a downhole unit. Other methods to transmit the data include acoustic transmission and mud-pulse telemetry. Alternatively, the data may be stored and/or processed in memory located at the string. The first logging instrument may be configured for logging-while-drilling (LWD) applications. The techniques disclosed herein are also suitable for wireline logging applications.

In one embodiment, the data acquisition unit 22, the logging instrument 18, and/or other components of the system 10 include devices as necessary to provide for storing and/or processing data collected from the logging instrument 18 and other components of the system 10. Exemplary devices include, without limitation, at least one processor, storage, memory, input devices, output devices and the like.

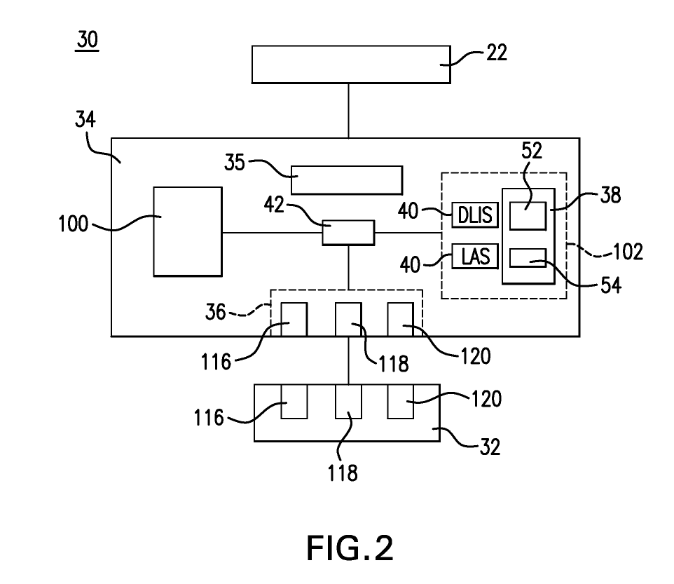

FIG. 2 illustrates an acquisition data (e.g., well log data) processing and delivery system 30 that is in communication with and can receive data from the borehole system 10 and/or the data acquisition unit 22. The configurations described herein are exemplary, as components of the system 30 may reside in the acquisition unit 22, a client computer 32 or other suitable location. In addition, the systems and methods described herein are not limited to well log data, and may be used for storage, conversion and/or delivery of any type of data_{:}

The system 30 includes a processor 34, such as a microprocessor and/or CPU, in which various software and hardware components reside. A software application 35, is responsible for receiving data from the acquisition unit 22 and providing the data to a requesting entity, such as a user or client computer 32. As described herein, a “component' may refer to a hardware or software component provided for performing one or more functions. For example, a software component may be a software package, application or module, object or set of objects for performing a function. Different components may communicate with one another via interfaces. Methods described herein may be performed by the application or one or more delivery components 36 in conjunction with data adapters as described further below.

In the embodiment shown in FIG. 2, the application 35 and/or delivery component 36 is in communication with a storage component 38, or simply “storage” 38, which may include memory spaces and software and programs for accessing the memory spaces. One or more data adapters 40 are included that can implement the VDM. As described herein, the VDM is a set of interfaces that allows the application 35 to operate on the acquisition data independent of the physical data format.

The application 35 (and/or component 36) interacts with other components, such as the data adapters 40 and storage 38 via one or more interfaces 42. A software interface is analogous to a hardware interface like a bus or pin assignments of an integrated circuit. It is a contract between two software modules (e.g., data adapters) that describes how they agree to communicate with each other. In addition, the interface provides privacy to each module such that they are free to implement the interface in any way they deem necessary without any pre-conceived expectations from the modules they will be communicating with. Other attributes of the interface include a virtual data model, as well as indications of various functionalities of an associated component (e.g., transactions, indexing, paging, versioning. etc.)

For each type of acquisition data file received, a data adapter 40 is provided that can be launched when an acquisition data file having a specific file format is received or requested. Examples of file formats include Digital Log Interchange Standard (DLIS) and Log ASCII Standard (LAS) formats. Data files having a specific format include acquisition data (e.g., measurement data or other deliverable data) as well as “business data”, or data that governs how the acqusition data is encoded or formatted in a file. Examples of business data includes meta-data, headers and identifiers.

The data adapter 40 is a component that exposes an interface to a corresponding type of data file, and gets loaded when the file type it supports is opened. The data adapter 40 is configured to expose its properties and methods associated to a particular well data file and hide from the application 35 all details of the underlying data format (e.g., the physical structure of the data in the file). Because the data adapter 40 is responsible for this processing, the application 35 is only required to go through a very minimal amount of business logic based on the file type, and from that point on the code is completely generic. An example of a data adapter is an ActiveX control. A specific data adapter (e.g., a DLIS data adapter or a LAS data adapter) is provided for each acquisition file type.

The adapter 40 implements a virtual data model (VDM) interface that hides the details of the data format that the adapter supports. Internally, the adapter 40 can convert the format into a generic secondary format (if necessary) that is fully capable of implementing the VDM interface. As such, the application 35 does not need to know which data format is being used, but instead only needs to understand the VDM interfaces.

Any adapter 40 may be created, as long as it understands the data format being used and can implement the VDM interface to make that data available to other modules or components in the system. The adapters 40 isolate the application 35 or component 36 from “rote functionality” (e.g., indexing, searching, caching, paging, filtering, transactions, etc.) so that various applications do not have to duplicate this effort.

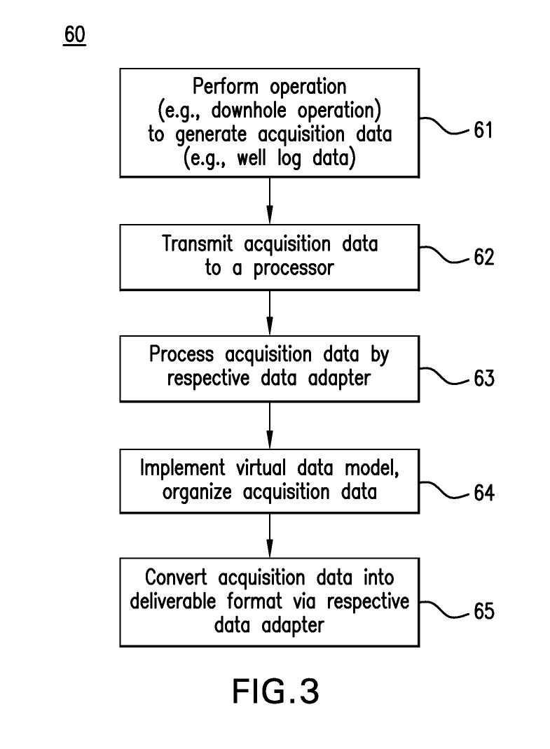

FIG. 3 illustrates a method 60 of processing and/or converting received acquisition data. The method 60 includes one or more stages 61-66. Although the method 60 is described in some examples as being performed in conjunction with the system 10 and/or the system 30, the method 60 is not limited to use with these embodiments. In one embodiment, the method 60 includes the execution of all of stages 61-66 in the order described. However, certain stages may be omitted, stages may be added, or the order of the stages changed.

In the first stage 61, a well logging, drilling and/or LWD operation is performed, for example, via the system 10 and the logging instrument 18. For example, resistivity or other measurement data (referred to herein as “acquisition data”) is taken over selected time windows during a duration of the operation to generate raw measurement data.

The acquisition data may include various types of data, such as curves, tables, images and text data. Groups of acquisition data files or data objects (described herein as “projects”) that are received may come from one well or one measurement operation, or come from multiple wells and/or operations.

In the second stage 62, the acquisition data is transmitted to the processor 34.

In the third stage 63, the acquisition data is read by the application 35 using a data adapter 40 that understands the acquisition data format. The data adapters 40 operate as separate components, and thus when a correction is made to one adapter, there is no chance of breaking functionality in another adapter. In the example shown in FIG. 2, a respective data adapter 40 is included to write the acquisition data received from the data acquisition unit 22 into deliverable formats such as DLIS and LAS file formats.

A respective data adapter 40, (e.g. acquisition data adapter, DLIS, or LAS adapter) isolates the application 35 and its components from the need to understand each individual data format. Instead these components acquire the information in these data formats using a generic or common set of interfaces referred to as the Virtual Data Model (VDM) interface, an example of which is shown as API 42.

The VDM provides instructions for communicating between each component and provides a virtual organization of the acquisition data by associating data items (e.g., curves, tables, images and text data) with virtual data elements and organizing the elements. The VDM provides an appearance of a structure of acquisition data that the application sees. For example, the VDM organizes elements based on parameters such as a project, well, measurement type, domain and others.

In one embodiment, the interface is based on a generic programming construct referred to as “streams.” Streams are the most basic element in a project. Every item stored in a project becomes a stream; data items such as curves, tables, images and text data all exist (after processing by the respective data adapter 40) as streams. “Streams” as described herein may refer to a stream of data, characters or bytes. Streams can grow simply by appending data to them, such as would be required by a curve that is receiving new data from a real-time source. Streams may be generated and stored by the data adapter 40 via a separate stream interface such as an IStream interface. Data adapters 40 responsible for reading the streams and converting the streams into a client file format may do so via the stream interface.

In the fourth stage 64, in one embodiment, the data adapter 40 implements the virtual data model. The data model describes various components and storages, as well as acquisition data organization.

For example, as part of the conversion or extraction of the acquisition data from the received format, the data adapter 40 organizes the various data streams generated from a project. In its simplest form, a project is a collection of streams, where streams are a collection of bytes. In one embodiment, the streams (or elements representing the streams) are collected in “storage objects” that represent data sources. Each storage object also has a collection of “groups” which are each collections of streams that share a common property.

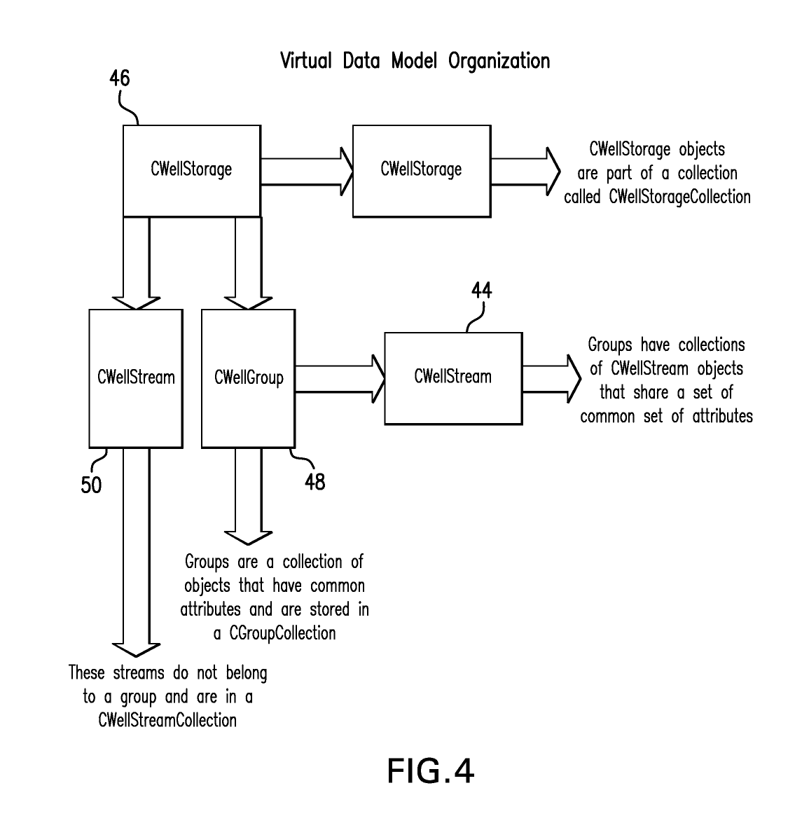

An exemplary data model by which streams are organized in the storage 38 is shown in FIG. 4. The model includes a collection of storage objects by which streams are organized and stored. Storage objects are data sources that are loosely interpreted to be whatever is appropriate for the application (wells, test data, etc.).

In one embodiment, each data acquisition item (such as a curve or curve segment) of a project, which has been opened or read by the data adapter 40, is represented by one or more stream objects 44 (also referred to simply as a “stream” 44). Each stream 44 may be stored in a project storage object 46. Streams that have common attributes (e.g., measurement type, well number, domain, etc.) may be stored together (within the storage object 46) in a group object 48 or group 48. Groups are collections of related streams, such as tables that define the presentation on a log, and curves that are sampled together and have the same number of levels. Unrelated streams may be stored together, for example, in a stream collection 50.

The stream interface may be configured to simply access the streams (e.g., an IStream interface), or may also include additional functionality for processing, accessing or analyzing the streams. In the case of the acquisition data being well data, exemplary interfaces used by the adapters 40 to communicate with the various objects include “IWellGroup” (a generic group which supports groups of blobs, images, and other types that do not have their own specialized stream interfaces), “ICurveGroup” (groups of curves), and “ITableGroup” (groups of tables).

Other exemplary interfaces include an “IWellStream” interface that inherits from IStream and provides some convenience methods and properties over the basic IStream interface. An “ICurveStream” interface inherits from IWellStream and provides convenience methods and properties that are appropriate for a curve such as the number of levels, data type, number of columns, seek to level, etc. An “IIndexStream” interface inherits from ICurveStream and provides convenience methods and properties to support the sorting and searching of an index curve (for indexing data by, e.g., depth, time or true vertical depth). An “IWellStreamTable” interface inherits from IWellStream and provides convenience methods and properties for supporting tables. Note that the above specialization examples of IStream are conveniences; ultimately everything could be done with the basic IStream interface.

In the fifth stage 65, upon receiving a request for well data, the application 35 or component 36 instantiates the relevant data adapter, which retrieves streams associated with VDM elements (e.g., groups) corresponding to the type of requested data (e.g., different curves, time frames, domains, etc.) In one embodiment, the requester (e.g., user) requests data having selected attributes. The relevant data adapter converts the streams in the corresponding group and delivers them in the requested format.

The method 60 can be applied to copy acquisition data from a first format to a second format, e.g., to copy a LAS project to a DLIS project. Although this example is described in conjunction with LAS and DLIS formats, the method may be utilized for any data file formats. In this example, the application 35 has an open LAS project and is requested to deliver acquisition data for that project in DLIS format.

The application 35 launches a DLIS adapter 40 (e.g., an ActiveX control entitled “DLIS.OCX”) and asks the adapter 40 to create a new DLIS file. The DLIS adapter 40 creates a DLIS file and releases control to the application. The application 35 then directs a LAS adapter 40 to enumerate all of its source streams (e.g., step through a catalog and/or read all of the data streams) into the LAS adapter (e.g., into a cache or storage for the adapter). The application also directs the DLIS adapter to create a corresponding store or file for the data streams (e.g., build a cache for the DLIS adapter).

The LAS adapter 40 then copies all of its streams to the corresponding file or cache in the DLIS adapter 40. The copy can be performed, for example, via a “CopyTo” command supported in the IStream interface, where the source stream copies itself to a given destination which is passed in as an IStream parameter. The application 35 asks the DLIS adapter to perform a save to commit the changes to the DLIS file. The DLIS adapter 40 recognizes that the DLIS file is not up-to-date with the cache and writes all of its streams into the DLIS file. The DLIS adapter 40 then returns control to the application. The application 35 asks the DLIS adapter 40 to close the project. From the application's point of view, it is just reading streams from one adapter and writing streams to another adapter.

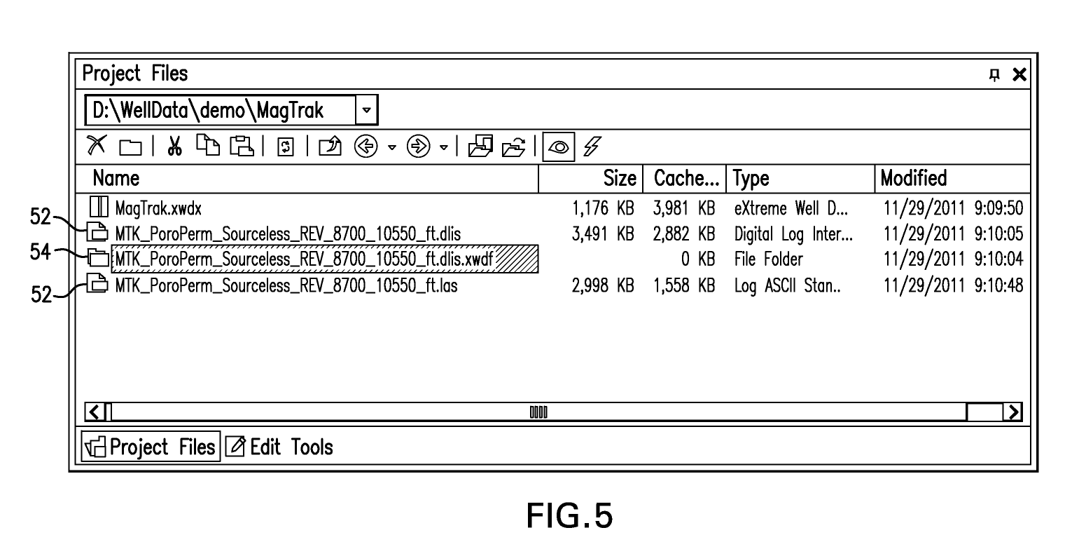

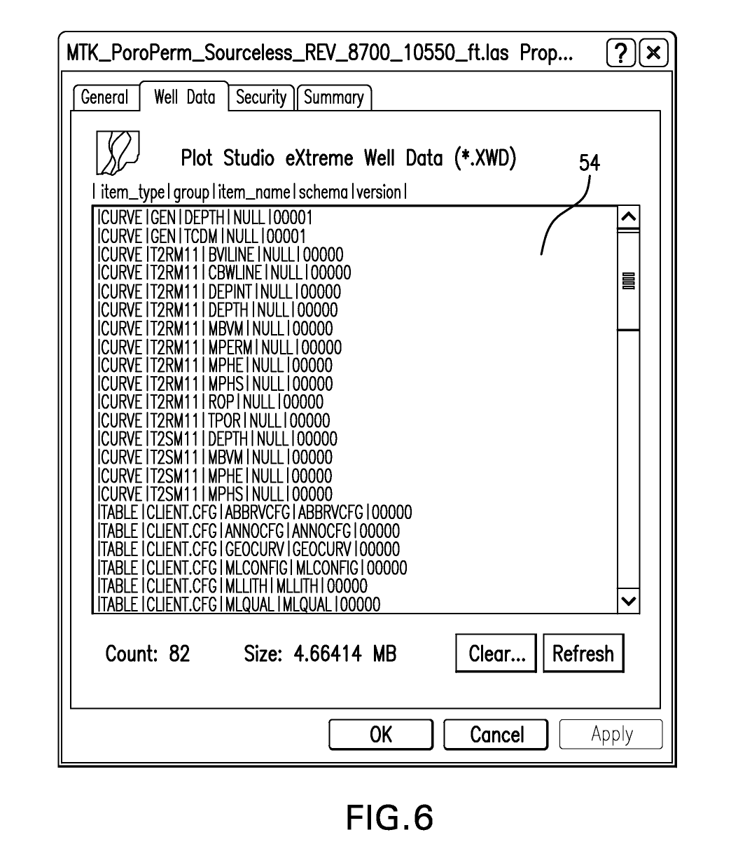

Referring to FIGS. 5 and 6, in one embodiment, after the data adapter 40 has converted the acquisition data into streams to hide the details of internal data formats (and saved business data via an interface), each stream and/or group is stored in a secondary storage or memory area. For example, the originally formatted acquisition data files are stored in a primary store 52. The data adapter 40 copies the acquisition data files, converts the acquisition data into streams and stores the data streams in a secondary store 54 or cache 54, which is used by the data adapter to implement the stream interface. As discussed above, the streams can be organized according to the VDM.

Exemplary storages are shown in FIGS. 5 and 6. The project in this example is entitled “MagTrak.XWDX” (a ZIP data format).

Two primary project stores 52 are shown in FIG. 5, one of which is stored as a LAS file (.las) and another is a DLIS file (.dlis). In this example, two different data formats were created for use as secondary stores: XWD and XWDF. The XWD format is -a data stream format based on the Microsoft Window's New Technology File System (NTFS), referred to as “Alternate Data Streams (ADS)”, and the XWDF is a file system folder (e.g., a Windows folder). The XWD storage is referred to as an ADS cache, and the XWDF storage is referred to as a well folder cache.

In one example, the primary store 52 labeled “.dlis” includes data files in a DLIS file format. The column labeled “Cache” shows the size of the secondary store 54 for the .dlis project, and the “Size” column displays the size of each primary store 52. The secondary store 54 includes streams generated by a DLIS data adapter 40 after processing the .dlis project.

The cache 54 for the DLIS file 52 is in the XWDF format and is thus created as a separate file folder. To create the cache 54, a DLIS data adapter 40 names the cache the same as the DLIS file and adds an XWDF extension. When the cache 54 is visible, it is possible to browse into the cache 54 and see all of the individual streams of the project file.

FIG. 6 references secondary stores 54 for the LAS file 52. The secondary store 54 shown in FIG. 6 is stored as alternate data streams within the LAS file 52. The secondary store 54 in FIG. 6 is not a separate folder, thus there is only one file and when the user copies the file to another location the cache goes with the LAS file 52.

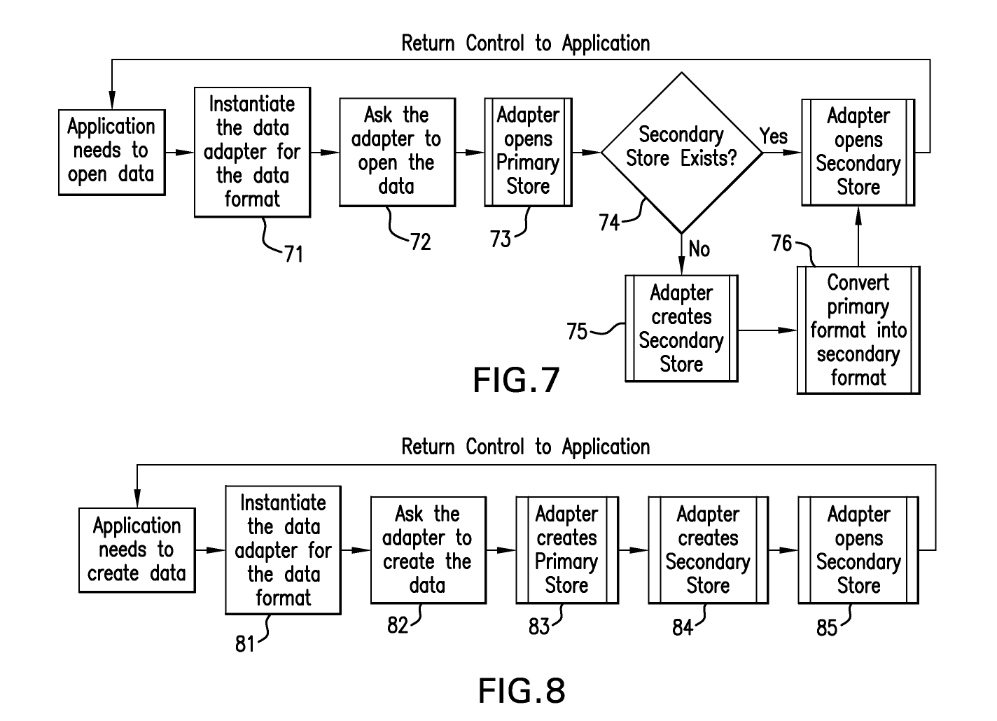

FIG. 7 shows an exemplary method by which data adapters are used to deal with different data formats. FIG. 7 illustrates an example in which an application 35 opens a project in a first format (e.g., a LAS file) that does not have a secondary store. In step 71, the application launches the LAS adapter 40 (e.g., an ActiveX control entitled “LAS.OCX”), and in step 72, the application 35 asks the LAS adapter 40 to open the LAS file. In step 73, the adapter opens the LAS file, which is stored in a primary store 52, and determines in step 74 whether a secondary store 54 is present. In step 75, the LAS adapter 40 detects that the secondary store 54 is missing and creates a cache (secondary store 54), and stores the resulting streams in the cache. In step 76, the LAS adapter 40 converts the LAS file into streams by parsing the text file from the LAS file, and stores the streams in the cache. The LAS adapter 40 then returns control to the application 35. All requests for acquisition data are now processed via the data adapter by manipulating the streams of the secondary cache. If a user opens the LAS file with a notepad, all they see is text. Under the covers however are individual streams that represent all of the elements contained in the LAS file.

If, however, the application 35 opens a LAS file that already has a secondary store 54, the secondary store 54 will speed up the opening of the LAS file because the text file does not need to be parsed again. For example, the application 35 launches the LAS adapter 40 (e.g., LAS.OCX) and asks the LAS adapter 40 to open the file. The LAS adapter 40 detects that the cache (secondary store 54) is present and does not need to parse the text file, and then returns control to the application 35. All requests are now processed by an adapter manipulating the streams of the secondary cache.

FIG. 8 shows a method by which the application 35 creates a new project. In step 81, the application 35 instantiates the relevant data adapter 40 for the requested data format, and in step 82 requests that the adapter 40 create the data streams. In step 83, the adapter 40 creates a primary store 52. In step 84, the adapter creates a secondary store 54. In step 85, the adapter 40 opens the secondary store 54. Control is then returned to the application 35.

The use of secondary stores allows for additional functionality that allows users to revert changes to a project without the need to copy files to a backup every time the project is opened. For example, when a typical word processor document is opened, the document is first copied to a backup and all of the editing is done on the backup file. If the user decides the editing has taken a wrong turn, they can just close the file without saving it, and the original data remains untouched.

Generally when working with well data projects, which can have large sizes (e.g., two gigabytes), copying a project every time it is opened may be unreasonable. Having a secondary store associated with a project offers a simple solution to this dilemma because the project is not monolithic, but is instead a collection of individual streams. For example, if a user opens a project and deletes a couple of curves and filters a couple of other curves and then realizes that he is working in the wrong curve group, the user can recover simply by not saving the changes.

In one embodiment, when a project is closed, the data adapter 40 looks for streams in the primary store 52 that are not in the secondary store 54 (this would not happen if the user committed the changes by doing a save), and then the missing secondary streams are reconstructed from the primary store 52. The data adapter 40 also looks for stream modifications by checking for changes in the stream's modification time (would not happen if the user committed the changes by doing a save), and then the modified secondary streams are replaced by the streams in the primary store 52.

Committing the transaction by doing a save reverses the behavior. The data adapter 40 looks for streams in the primary store 52 that are not in the secondary store 54, and then deletes the same streams in the primary store 52. The data adapter 40 also looks for stream modifications in the secondary store by checking for changes in the stream's modification time, and then the modified secondary streams are copied into the primary store 52. This simple form of transactions avoids having to make a backup of the project every time it is opened.

The adapters 40, as part of the virtual data model, can group the streams of a project into different groups to allow easy transitioning between multiple indices (e.g., measured depth, date/time, and true vertical depth). The design should not depend on “regulated” curve data (fixed spaced data, or data that has been converted to regularly spaced data in some domain). Grouping the project streams into relevant groups relieves the application 35 of indexing and allows for quick retrieval of data having requested parameters.

One type of group that is useful for indexing and presenting well data is a “curve group.” The concept of a curve group is similar to a DLIS frame; curves in the same group share a common sample rate, have the same number of levels, and are depth/time aligned. In one embodiment, if the model supports versioning, the curves in a group also share the same version.

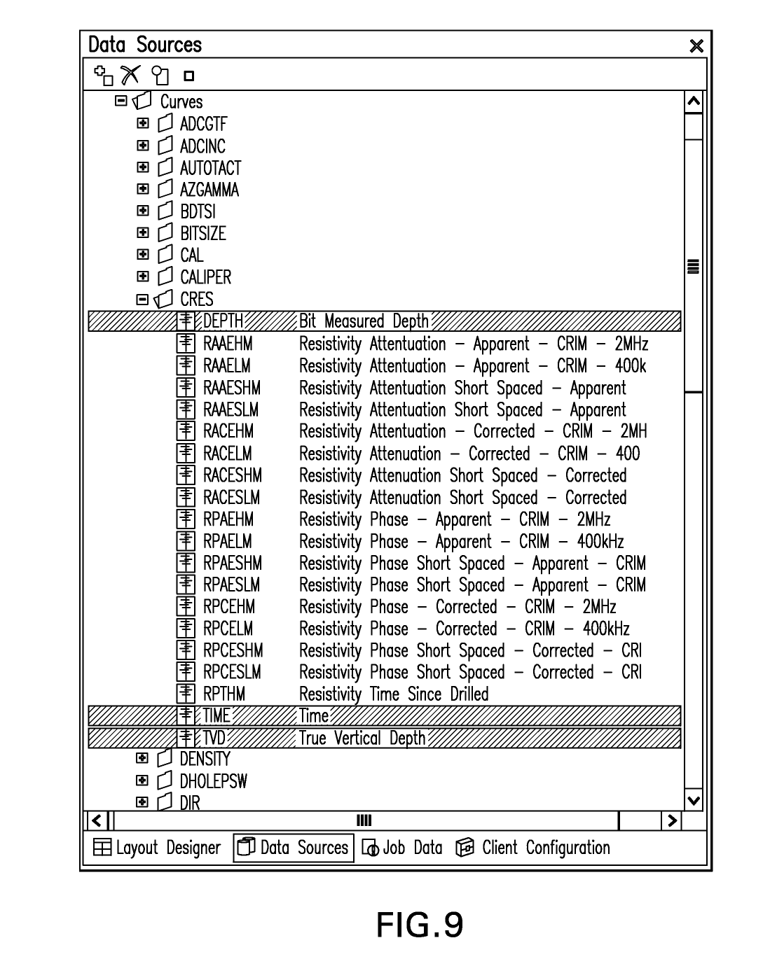

FIG. 9 illustrates a variety of curve groups, i.e., curves organized by certain common parameters, which are defined in the VDM. Exemplary groups include gamma ray measurement data, bit size, and measurement data resistivity curves (shown in FIG. 9 as a “CRES” curve group). As shown, each group includes multiple streams indexed according to types of resistivity measurements.

In one embodiment, each curve group 48 may include one or more “indexing curves” that are used to sort data based on the current “presentation mode”. Exemplary indexing curves allow curves to be presented according to selected modes, such as “Bit Measured Depth”, “Time” and “True Vertical Depth” (TVD). For example, the curves shown in FIG. 9 that are part of the CRES group can be displayed according to the indexing curves DEPTH, TIME and/or TVD. Examples of such presentations include displaying corrected resistivity attenuation (RACHM) and corrected short-spaced resistivity attenuation (RACLM) in the time domain and the depth (i.e., measured depth or true vertical depth (TVD)) domain. The curve group behaves like an un-regulated LAS file in that all of the curves obtain their depth from the “Bit Measured Depth” curve. This makes it easy to display unregulated data and it also makes it easy to switch the presentation to another mode like TVD or Time.

In one embodiment, the groups 48 are organized and indexed according to the VDM prior to translating into a specific file format. In this way, the original acquisition data is kept intact until a deliverable (acquisition data in a requested format) is generated for a customer, at which point the data is regulated to files having the requested format (e.g., LAS or DLIS files). An advantage of being able to use unregulated data is that the logs are as close to the original data supplied by the acquisition system as is possible.

Dividing the project up into curve groups that share a common sample rate provides the ability to work with unregulated data and greatly reduces the time required to switch between presentation modes. There is an added advantage of being able to do elastic depth shifts without having to resample the data; data points in the index curve are all that needs to be changed.

In one embodiment, data adapters 40 are responsible for indexing, thus isolating the application 35 from rote functionality. As discussed above, indexing allows for quick transitions into multiple domains (e.g., depth, time, and TVD). The indexing functionality of the adapters 40 also provides additional capabilities, such as rapid searching for the level associated with a given index, sequential access to data from a pair of indices, filtering based on direction of data, and filtering out invalid indices (e.g., null data, not a number, or not finite).

In one embodiment, each data adapter 40 is also responsible for supplying sequential data. This is particularly useful in working with un-regulated data, i.e., data that has not been converted into regularly spaced data, which would typically require an application to search for the next level of data that is being delivered or presented according to some domain and/or filter.

For example, as the user scrolls through a well log, the application 35 needs to find all of the points from just above the top of the screen to just below the bottom of the screen. There could be thousands of levels visible on the screen for each curve being presented. Searching for each of those points would greatly slow down the speed a presentation could be scrolled. The data adapter 40 addresses this by sorting the streams into an array of “sorted valid” levels which allows the application 35 to step through the levels sequentially similar to what happens when working with unregulated data. The levels are sorted and may also be “validated” by removing levels that are considered invalid, e.g., null data, data that is not a number or not finite, and data that is part of invalid transactions.

The data adapter 40 can thus present and/or deliver data streams in a sequential fashion by organizing or indexing streams according to the domain associated with the data and types of data. For example, generally a user would not want to see a presentation that includes curves displaying all acquired data and curves in all domains. Unregulated data allows for such presentations, however a user can specify certain presentation modes. For example, a user can specify a “Presentation Mode” (e.g., depth, time, or TVD) and a “Plot Mode” (e.g., All Data, Drilling Data, or Back Plot Data).

For example, if the Plot Mode is changed from All Data to Drilling Data, curves can be displayed that include only the drilling data and exclude other data. In this case all of the measurements that were made while not drilling have been discarded by the indexer. Having these responsibilities off-loaded to data adapters means that all of the applications that use these adapters do not end up duplicating this effort.

Another functionality of the data adapters 40, in one embodiment, is versioning. A common scenario with well log data is to process the data in some manor such as depth shifting, but wanting to preserve the original data. Without versioning, an application 35 can do one of two things: output the new (processed) data to another project file, or output the new data to the same project using a different name. Embodiments described herein allow one to keep all of the data in the same project file, as renaming curves is generally not desirable (e.g., presentations are linked to the curve's name and will be broken if the curve is renamed). For example, a user can specify versioning, which causes the data adapter 40 to copy the relevant streams to a different version of the streams so that the curve can be edited without modifying the initial data. By supporting versioning, the processed data can keep the original name and reside in the same project file.

In one embodiment, data adapters 40 are responsible for paging the data into memory using a “least recently used” algorithm. This avoids the need to read an entire curve into memory when trying to render it on a data display (e.g., a log).

For example, the application 35 is responsible for passing paging parameters to a data adapter 40 via an interface that specifies a number of pages in memory at one time, and the number of data levels in each page. In one embodiment, these settings are made available in a generic file (e.g., a XML file) so the numbers could be optimized across all of the various data formats.

When the application 35 asks for a level of curve data, the adapter 40 checks to see if the level is in one of the pages, and if not loads the page into memory. If the maximum number of pages is already in memory, the oldest page is removed from memory first.

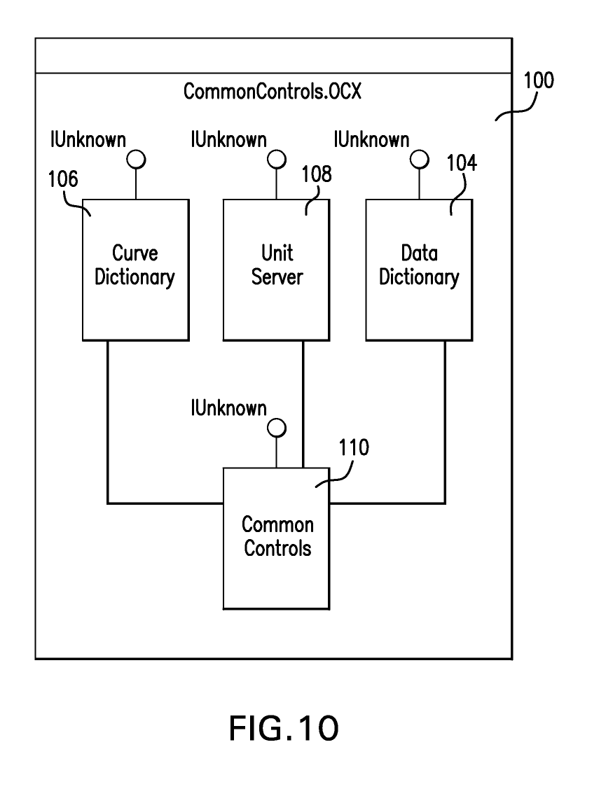

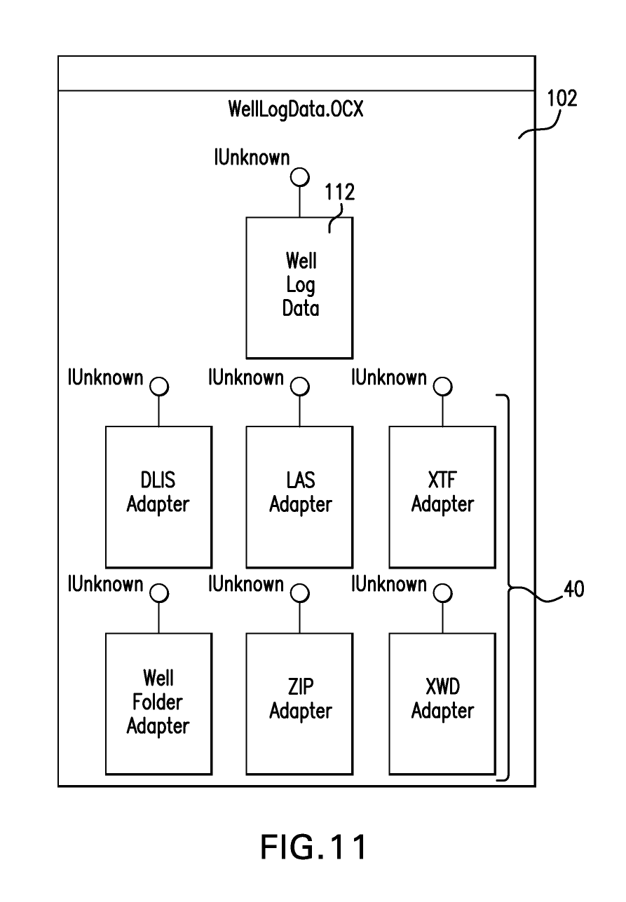

Referring to FIGS. 10-12, an embodiment of the processing system 30 implements as part of the VDM, an interface for organizing collections of data for access by various components (e.g., delivery components). Collections of data are provided that can be used by components to store, convert and deliver data. In one embodiment, the system 30 includes two data collections, described herein as “data buses”. A first data bus 100, shown in FIG. 10 and referred to as a “Knowledge Base”, is a collection of data that is available independent of any particular project and who's lifetime corresponds to the lifetime of the application 35. FIG. 11 shows a “Well Log Data” bus 102, which is a collection of data that is specific to a project and whose lifetime corresponds to the lifetime of the project.

The Knowledge Base Bus 100 serves to keep much of the business logic in knowledge bases, and out of the application code, allowing software to become far more flexible. The embodiment shown in FIG. 10 includes various exemplary knowledge bases (i.e., collections of business data). A “Data Dictionary” knowledge base 104 includes business data providing knowledge about how a table is created, accessed, and presented. A “Curve Dictionary” knowledge base 106 includes business data providing knowledge about how a curve is created, accessed, and presented. A “Unit Server” knowledge base 108 includes business data providing knowledge about unit classes, unit sets, and unit conversion.

Each of these knowledge bases may be implemented as a component with a well-known interface. Like the data adapters 40, there may be more than one component that can implement the interface and the one that is used depends on the environment it is used in. For example, if the application 35 is running on a computer with the acquisition system 22, the component loaded may share resources with the acquisition system 22.

The interface from each of the knowledge bases is passed into the data adapters 40 when they are loaded. An example of how they are used would be in the case of a LAS file where there is no knowledge of what the original data types are when parsing the text file. The LAS adapter 40 can use the curve dictionary 106 to create a curve stream using the preferred data type instead of having to default everything to a double precision floating point value.

In one embodiment, the business logic involved in loading the correct knowledge base 104, 106, 108 and distributing the interfaces is incorporated in a single component that exposes one control interface 110. An exemplary interface 110 is called “ICommonControls”, which is seen by other components as the Knowledge Base bus and is the only interface necessary to be passed to other components.

Referring to FIG. 11, the Well Log Data bus 102 includes various data adapters 40 and may be implemented by one or more interfaces that are responsible for loading the correct data adapter for any given data format and initializing the adapter with the interfaces from the Knowledge Base Bus 100. An exemplary interface is shown as an IWellLogData interface 112. Various examples of the data adapters 40 are shown, i.e., a DLIS adapter, a LAS adapter, a XTF adapter, a Well Folder adapter, a ZIP adapter and a XWD adapter.

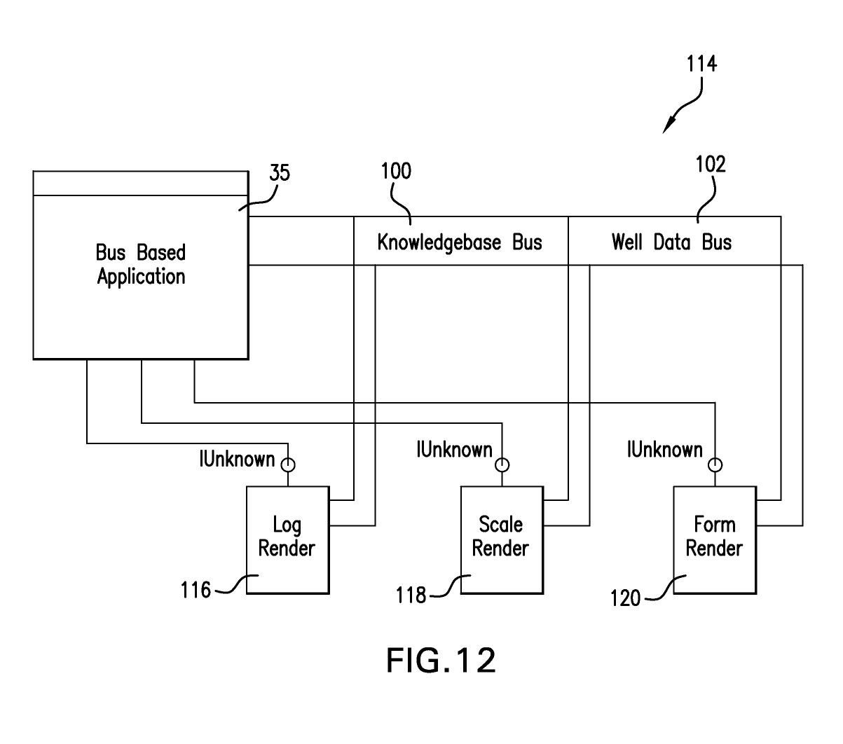

Referring to FIG. 12, the application, data buses and various components form part of a data bus architecture 114. In this embodiment, the data adapters 40 are clients of the Knowledge Base Bus 100.

In one embodiment, components 36 of the processing system are implemented in the data bus architecture as “smart components” because they know what information they require and are smart enough to pull that information off of the buses. Exemplary smart components include delivery/display components such as a log rendering component 116, a scale rendering component 118 and a form rendering component 120.

Smart components are clients of the data bus architecture 114 and represent a role reversal from conventional architecture where the application has to understand the data needs of all of the components it hosts. In a conventional application, each component used by an application exports all of the properties it requires to do its task. The application is responsible for gathering the information and “pushing” it into the component. The problem is that with complex components, such as log rendering components, there can literally be several hundred properties necessary to drive the component. Examples of such properties include single sample curve presentation, waveform presentation, grid presentation, annotation, zonation, fills, raw curve data, and client configuration properties. There can be around 200 properties associated with curve presentation alone. Every application that uses the log component has to know how to gather this information and push it into the component.

In contrast, the data bus architecture 114 described herein only requires that the application 35 instantiate the data buses 100, 102, and the smart components 116, 118, 120 are able to pull the data off of the buses that they need.

In this design, the components still expose interfaces, but instead of pushing data into interfaces via a large set of properties they pick the data off of the appropriate bus. “Dumb components”, or components without the capability to select data from the data buses 100, 102, can be made into smart components by wrapping them in a smart component. This reduces the size of the component interface and focuses it on how the application will control it.

Every smart component that is written understands its data requirements and can be expected to be able to retrieve them from the data buses 100, 102, as opposed to every application that uses the component having to know what every component's data requirements are. This means that applications can be simpler to write and reduces the duplication of effort between applications. Instead of passing in the data in a large set of properties, the application just has to pass in the interface to the bus.

The following code routine example illustrates how the system 30 can isolate the application from data formats, and direct data adapters 40 to copy one data format to another using simple code. A first portion of the code follows:

| | |
|---|---|
| Code: | Explanation: |

AfxOleInit( );
::CoInitialize( NULL );

| | |
|---|---|
| IPathsAndSettingsPtr spPaths; | use paths and settings to read the |
| spPaths.CreateInstance( _{——}uuidof( | customization |

PathsAndSettings ));

const CString csCustom =

(LPCTSTR)spPaths−
>Customization;

| | |
|---|---|
| ICommonControlsPtr spCC; | ICommonControls interface contains |
| spCC.CreateInstance( _{——}uuidof( | knowledge base: |

| | |
|---|---|
| CommonControls )); | Curve Dictionary |

| | |
|---|---|
| spCC−>LoadCommonControls( ); | Data Dictionary |
| spCC−>Customization = | Unit Server |

csCustom.AllocSysString( );

| | |
|---|---|
| IWellLogDataPtr spSourceWLD, | launch the source and destination |

| | |
|---|---|
| spDestWLD; | well log data objects (WLD) |

spSourceWLD.CreateInstance(

_{——}uuidof ( WellLogData ));

| | |
|---|---|
| spDestWLD.CreateInstance( | give the WLD access to the |

| | |
|---|---|
| _{——}uuidof( WellLogData )); | knowledge base |

spSourceWLD−>CommonControls =

spCC;

| | |
|---|---|
| spDestWLD−>CommonControls = spCC; | |
| spSourceWLD−>Customization = | let the WLD know what |

| | |
|---|---|
| csCustom.AllocSysString( ); | customization is being used |

spDestWLD−>Customization =

csCustom.AllocSysString( );

| | |
|---|---|
| spSourceWLD−>Pathname = | have the WLD object launch the |

| | |
|---|---|
| csSource.AllocSysString( ); | proper adapters |

spDestWLD−>Pathname =

csDest.AllocSysString( );

| | |
|---|---|
| IWellDataPtr spSourceData = | get the well data interface to the |

| | |
|---|---|
| spSourceWLD−>WellData; | source adapter |

| | |
|---|---|
| IWellStorageCollectionPtr | interface to container of storages |

| | |
|---|---|
| spSourceStorages = | for source |
| spSourceData− | |
| >WellStorageContainer; | |

| | |
|---|---|
| IWellStoragePtr spSourceStorage = | a single source secondary storage |

| | |
|---|---|
| spSourceStorages−>Item[ 0 ]; | is created automatically |

| | |
|---|---|
| IWellDataPtr spDestData = | get the well data interface to the |

| | |
|---|---|
| spDestWLD−>WellData; | destination adapter |

| | |
|---|---|
| IWellStorageCollectionPtr | interface to container of storages |

| | |
|---|---|
| spDestStorages = | for destination |
| spDestData- | |
| >WellStorageContainer; | |

| | |
|---|---|
| IWellStoragePtr spDestStorage = | a single destination secondary |

| | |
|---|---|
| spDestStorages−>Item[ 0 ]; | storage is created automatically |

As shown in the above portion of the code, the routine begins by creating an instance of the knowledge base interface 110 (CommonControls.OCX) which is responsible for loading the Knowledge Base Bus 100 to support the data model's “data driven” design. The interface 110 is responsible for the business logic necessary to load the proper controls based on where the user is running. Primarily, the interface 110 determines if the acquisition system is available and if not loads a set of controls that do not depend on the acquisition system's services.

The WellLogData.OCX interface 112 is the control responsible for implementing the VDM and loading the correct data adapter 40 to support the given data format. When the source and destination pathnames are passed into the interface's Pathname property, the correct adapter is instantiated.

A second portion of the code follows:

| | |
|---|---|
| spSourceStorage−>Open( (LPCTSTR) | open the source data (from |

| | |
|---|---|
| csSource ); | the secondary store) |

spDestStorage−>Create( (LPCTSTR)

| | |
|---|---|
| csDest, VARIANT_FALSE ); | create the destination data |

| | |
|---|---|
| IDispatchPtr spDisp; | |
| spDestStorage−>QueryInterface( | copy the source storage to |

| | |
|---|---|
| &spDisp ); | the destination secondary |

| | storage |
|---|---|
| spSourceStorage−>CopyTo( spDisp ); | |
| spDestStorage−>Close( ); | |
| spSourceStorage−>Close( ); | close the destination file |

| | |
|---|---|
| ::CoUninitialize( ); | close the source file |

The second portion shows how the code retrieves the interface to the source and destination interfaces. The source interface is used to open the source file and the destination interface is used to create the destination file. With the source file open and the destination file created, the “CopyTo” method copies the source storage to the destination storage and in the process converts from one file format to another.

The data bus architecture described herein can be used to control the creation, collection, modification and presentation of tabular data via tables governed by the knowledge bus. The concept of a table is the basis of relational databases because a table provides an ideal means of relating data by providing multiple properties (columns of the table) that are related by being on the same row of the table.

The use of tables as described herein illustrates a design principle referred to as “data driven design” where the business logic to create, convert, and present data is controlled by information collected from the Knowledge Base Bus 100.

For example, survey data is stored in tables that are governed by the Data Dictionary 104 and Unit Server 108 knowledge bases, which are used together to modify application behavior at run time without the need write code or re-compile. In addition to storing customer data in tables, the presentation information to display the data is also stored in tables.

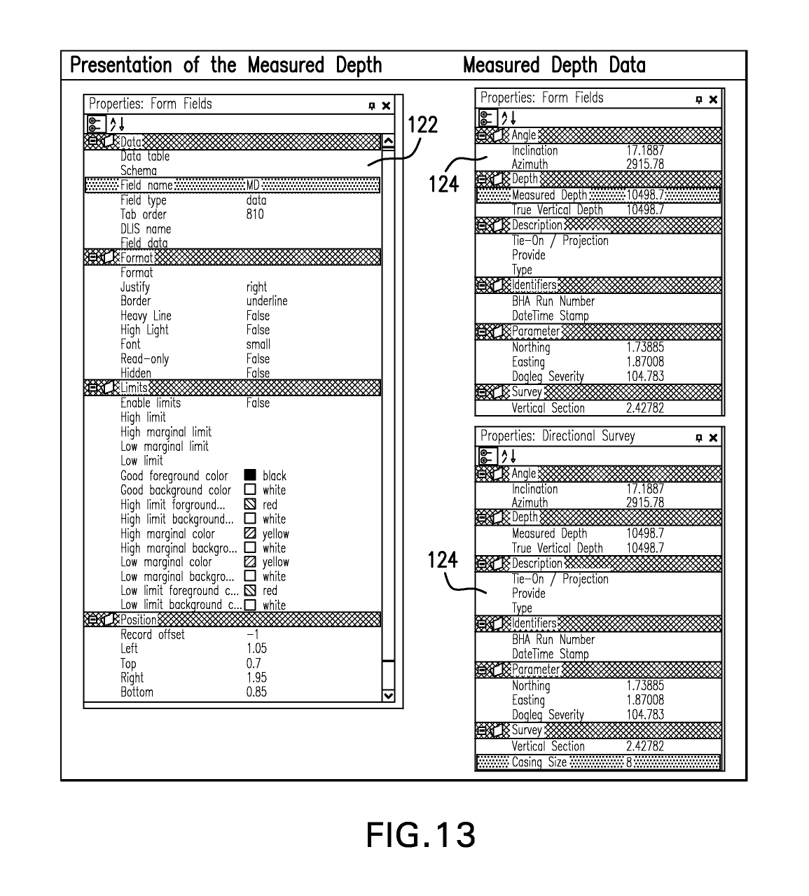

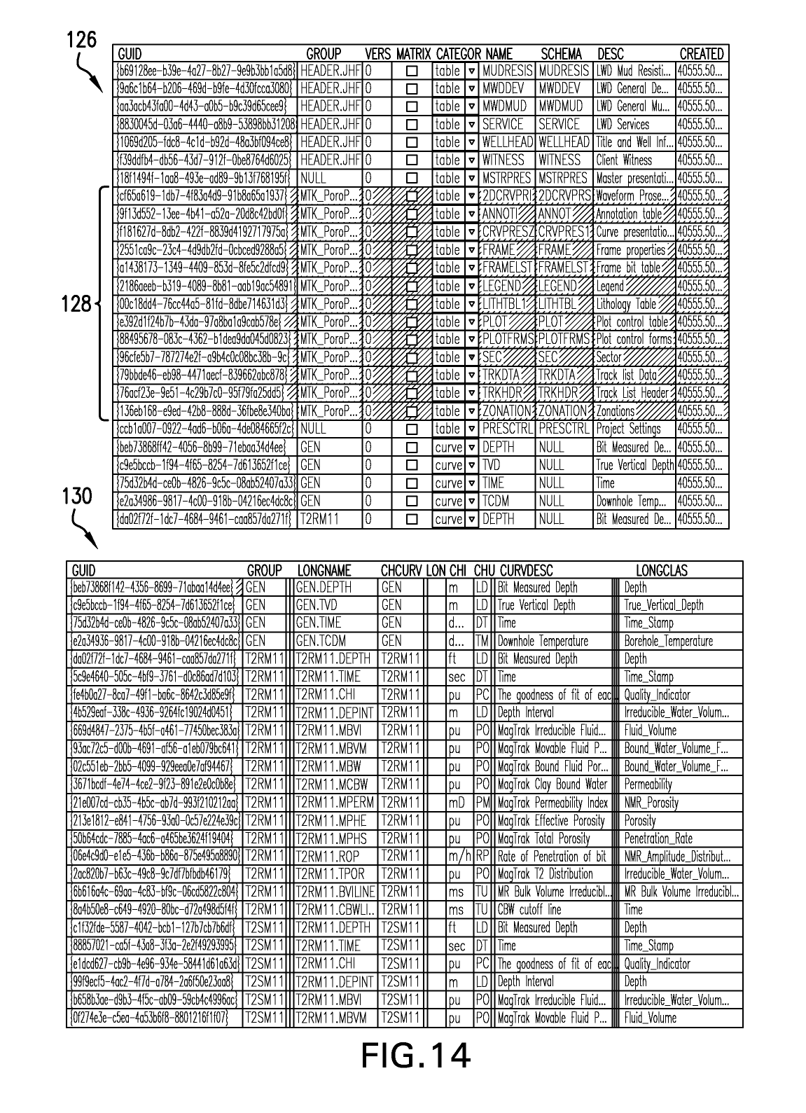

FIG. 13 illustrates a user interface for exemplary tables for a collection of survey data. A first table 122, shown via a user interface, is a form table that provides the format for presentation of the acquisition data, and a second table 124, shown via the user interface, provides the actual survey data (i.e., acquisition data). The same class is used for the user interface for all tables (e.g., categories, the property labels, the data entry format, etc.), and all tables are controlled by the Data Dictionary.

An exemplary XML code line which controls the “Measured Depth” column of the survey data table 124 follows:

| <Column FIELD=“MD” | | FIELD: Name of the table's column |
|---|---|---|
| | TYPE=“string” | TYPE: of data (float, Boolean, etc.) |
| | SIZE=“16” | SIZE: in bytes |
| | UNITS=“LD” | UNITS: unit class (length & depth) |
| | DATATYPE=“DEPTH” | DATATYPE: data type definition |
| | ALIAS=“” | ALIAS: for the column name |
| | TITLESM=“MD” | TITLESM: small title used in grids |
| | TITLELG=“Measured Depth” | TITLELG: large title for properties |
| | DESC=“Measured Depth” | DESC: description of the data |
| | EDIT=“multi-row” | EDIT: edit constraints |
| | ENTRY=“free” | ENTRY: how the data is entered |
| | CUSTOM=“” | CUSTOM: customized entry |
| | GROUP=“Depth” | GROUP: how data is grouped |
| | INDEXHIDE=“” | INDEXHIDE: hide field by index |
| | FIELDHIDE=“” | FIELDHIDE: hide field by other |
| | | fields |
| | ROLEHIDE=“” | ROLEHIDE: hide field by user role |
| | UPDATEDB=“auto”> | UPDATEDB: database update |

| | |
|---|---|
| | options |
| </Column> | |

A single class is data driven by the Data Dictionary to control how the data is presented and modified by the user, which allows the application 35 to avoid writing custom code for every table definition. A simple XML change can be used to modify a table. For example, an additional parameter is added to the survey table 124, e.g., a “Casing size” parameter, by the following XML line:

| <Column FIELD=“SIZE” | | FIELD: Name of the table's column |
|---|---|---|
| | TYPE=“string” | TYPE: of data (float, Boolean, etc.) |
| | SIZE=“41” | SIZE: in bytes |
| | UNITS=“DI” | UNITS: unit class (diameter) |
| | DATATYPE=“CASING_DIAMETER” | DATATYPE: data type definition |
| | ALIAS=“idSection” | ALIAS: for the column name |
| | TITLESM=“Size” | TITLESM: small title used in grids |
| | TITLELG=“Casing Size” | TITLELG: large title for properties |
| | DESC=“Outside diameter” | DESC: description of the data |
| | EDIT=“multi-row” | EDIT: edit constraints |
| | ENTRY=“free” | ENTRY: how the data is entered |
| | CUSTOM=“” | CUSTOM: customized entry |
| | GROUP=“Survey” | GROUP: how data is grouped |
| | INDEXHIDE=“” | INDEXHIDE: hide field by index |
| | FIELDHIDE=“” | FIELDHIDE: hide field by other fields |
| | ROLEHIDE=“” | ROLEHIDE: hide field by user role |
| | UPDATEDB=“auto”> | UPDATEDB: database update options |

</Column>

After adding the above line to the XML, the survey data properties will now include a “Casing Size” column as shown in FIG. 13. In this example, the value 8 is entered for the Casing Size which is using the DI unit class (diameter). The meaning of the value depends on the current unit set. In this case the unit set is “English” which uses inches for diameter. If the unit set is changed to metric, the diameter size can be displayed in millimeters. If the user saves these changes, when the project is reopened the Casing Size changes will be restored including the “Casing Size” column. Thus, with one line of XML, one is capable of creating a custom user interface for a new data parameter, handle unit conversion and handle persistence into and out of the project. All of this functionality does not require any code changes, no re-compiles, and if necessary can take place in the field. It is noted that suitable codes are not limited to those described herein.

Embodiments of tables described herein as they relate to the data model have two important characteristics: they are self-describing, i.e., they have an embedded data dictionary, and they are created, accessed, and presented with the support of the Data Dictionary knowledge base 104. There are three interfaces in the data model that relate to tables. An “ICaseTable” interface is provided to access data in tables. An “IWellStreamTable” interface is inherited from the IWellStream interface to provide stream I/O to the tables. An “IDataDictionary” interface (e.g., an ActiveX control entitled “DataDictionary.OCX”) is the primary interface of the Data Dictionary knowledge base 104 which is used to create, access, and present tabular data. The Data Dictionary knowledge base 104 component knows what the current schema of the table is, so when a new table is created, it is created with the latest schema definition. The application code uses the IDataDictionary interface by calling the ISchemaCollection::CreateTable method which only needs a schema name as its input and is returned as an ICaseTable interface. If an older project is opened that was created with an earlier schema, the Data Dictionary will ask the ICaseTable interface to convert the data to the new schema. In one embodiment, the store for the Data Dictionary knowledge base 104 is an XML file that is read at run-time.

More complex relationships can be created by linking tables together. For example, as shown in FIG. 14, the data model defines two tables; a “catalog” table provides a minimal set of properties for all of the streams in a project, and a “curve heading” table provides a complete set of properties for all of the curves in a project.

An exemplary section of a catalog table 126 is shown in FIG. 14. The highlighted section 128 illustrates how tables can be grouped together, where in this case the group of tables represents a presentation group called “MTK_PoroPerm_Sourceless_REV.” A column such as the “GUID” column is used to relate information from one table to another (such as from the catalog to the curve heading table). The catalog table 126 also keeps track of creation and modification date/times.

A curve heading table 130 is also shown in FIG. 14. The GUID column for a GEN.DEPTH curve is highlighted and illustrates how information from one table is linked to another table (the GUID in the survey table 130 matches the GUID in the catalog table 126 for the same curve). While the catalog table 126 in this example only has 12 properties, the curve heading table 130 in this example has 63 properties and it would be a waste to put all of the properties in the catalog since image, table, and other streams do not need these properties. Instead, separate tables are created and linked together via a GUID column. The group names, column names and data described in this example are exemplary and are not limiting. Linking as described in conjunction with FIG. 17 can be used to link and/or relate tables and data of any type.

Generally, some of the teachings herein are reduced to an algorithm that is stored on machine-readable media. The algorithm is implemented by the computer processing system and provides operators with desired output.

In support of the teachings herein, various analysis components may be used, including digital and/or analog systems. The digital and/or analog systems may be included, for example, in the downhole electronics unit 42 or the processing unit 32. The systems may include components such as a processor, analog to digital converter, digital to analog converter, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

What is claimed is:

1. A method of processing data, the method comprising:
receiving by an application acquisition data from at least one data acquisition source, the acquisition data having a first data format, the first data format including the acquisition data and business data related to the first data format;
instructing a software component to access the acquisition data; and
processing the acquisition data by the software component, wherein processing includes separating the acquisition data from the business data and making the acquisition data available to one or more other components via a common interface that can be implemented by the software component and the other components.

2. The method of claim 1, further comprising:
receiving by the application a request to deliver the acquisition data in a requested format; and
accessing the acquisition data by a data adapter via the common interface, the data adapter configured to read the requested format;
converting the acquisition data into the requested format and delivering the acquisition data in the requested format.

3. The method of claim 1, wherein the acquisition data includes data generated by a downhole operation.

4. The method of claim 1, wherein the common interface includes a virtual data model by which the component organizes the acquisition data, the virtual data model implemented by the software component and the other components.

5. The method of claim 2, wherein delivering the acquisition data includes reading the separated acquisition data via the common interface and converting the separated acquisition data into a second data format by a data adapter.

6. The method of claim 1, wherein processing the acquisition data includes storing the acquisition data having the first data format in a first primary store and storing the separated acquisition data in a first secondary store associated with the first primary store.

7. The method of claim 6, wherein processing the acquisition data includes:
instantiating an additional data adapter;
creating a second primary store and a second secondary store by the additional adapter;
copying the separated acquisition data from the first secondary store to the second secondary store;
converting the separated acquisition data in the second secondary store into a second data format; and
storing the acquisition data in the second data format in the second primary store.

8. The method of claim 1, wherein processing includes converting the acquisition data to a data stream format in which the acquisition data is stored as at least one stream.

9. The method of claim 8, wherein the common interface includes a virtual data model (VDM), and processing includes associating the at least one stream with a project element in the VDM, and associating acquisition data having common parameters with a group element within the project element.

10. The method of claim 9, wherein the acquisition data includes one or more curves, and the group element includes curve elements organized by curve parameters.

11. The method of claim 1, wherein processing includes accessing one or more knowledge base storages, each knowledge base storage including business data describing how different types of data are processed, the business data independent of individual acquisition data items.

12. A system for processing data, comprising:
a processor including an application configured to receive acquisition data from at least one data acquisition source, the acquisition data having a first data format, the first data format including the acquisition data and business data related to the first data format; and
at least one software component configured to access and process the acquisition data, wherein processing includes separating the acquisition data from the business data and making the acquisition data available to one or more other components via a common interface that can be implemented by the software component and the other components.

13. The system of claim 12, wherein the at least one software component includes a data adapter configured to read a requested data format, the data adapter configured to access the acquisition data via the common interface, convert the acquisition data into the requested format and deliver the acquisition data in the requested format.

14. The system of claim 12, wherein the acquisition data includes data generated by a downhole operation.

15. The system of claim 12, wherein the common interface includes a virtual data model by which the component organizes the acquisition data, the virtual data model implemented by the software component and the other components.

16. The system of claim 13, wherein delivering the acquisition data includes reading the separated acquisition data via the common interface and converting the separated acquisition data into a second data format by a data adapter.

17. The system of claim 12, wherein processing the acquisition data includes storing the acquisition data having the first data format in a first primary store and storing the separated acquisition data in a first secondary store associated with the first primary store.

18. The system of claim 17, wherein processing the acquisition data includes:
instantiating an additional adapter;
creating a second primary store and a second secondary store by the additional adapter;
copying the separated acquisition data from the first secondary store to the second secondary store;
converting the separated acquisition data in the second secondary store into a second data format; and
storing the acquisition data in the second data format in the second primary store.

19. The system of claim 15, wherein the common interface includes a virtual data model (VDM), and processing includes:
converting the acquisition data to a data stream format in which the acquisition data is stored as at least one stream; and
associating the at least one stream with a project element in the VDM, and associating acquisition data having common parameters with a group element within the project element.

20. The system of claim 12, wherein processing includes accessing one or more knowledge base storages, each knowledge base storage including business data describing how different types of data are processed, the business data independent of individual acquisition data items.
